(19) United States
(12) Patent Application Publication
(10) Pub. No.: US 2008/0317136 A1
(43) Pub. Date: Dec. 25, 2008

(54) TRANSCODER, IMAGE STORAGE DEVICE, AND METHOD OF STORING/READING IMAGE DATA

(75) Inventors: Mitsuaki HINO, Kawasaki (JP); Kazuyuki Tanaka, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/111,720

(22) Filed: Apr. 29, 2008

(30) Foreign Application Priority Data
Jun. 20, 2007 (JP) 2007-162665

(51) Int. Cl. H04N 7/26

(52) U.S. Cl. 375/240.26; 375/E07.198

(57) ABSTRACT

A transcoder capable of efficiently utilizing a large-capacity storage medium, of efficiently coping with diverse and complex standards, and of reducing power consumption has been described. To the transcoder, first format image data encoded in a first format is input and the transcoder outputs the first format image data and second format image data encoded in a second format different from the first format, wherein the transcoder comprises an interface with a storage device and a storage device control part that controls the storing and reading in the storage device via the interface and simultaneously stores the image data of the first and second formats of the same image in the storage device via the interface.

### CROSS-REFERENCE TO RELATED APPLICATION

This application is based upon and claims priority from prior Japanese patent application No. 2007-162665, filed on Jun. 20, 2007, the entire contents of which are incorporated herein by reference.

### BACKGROUND

1. Field

The present embodiment relates to a method of storing/reading image data for storing image data. For example, image data is input in a hard disc drive (HDD), a digital video disc (DVD), etc., and the embodiment may be outputting stored image data at the request of a user. The embodiment may include a transcoder to which image data, i.e., a first format image data encoded in a first format, such as MPEG2, is input and which outputs second format image data other than the first format image data, such as H.264 and VC-1, in addition to the first format image data, an image storage device that has such a transcoder, and a method of storing/reading image data.

2. Description of the Related Art

In the digital broadcast, a compression system that utilizes correlation between pictures, such as MPEG2, is used as a motion image compression format. Currently, in a digital broadcast, data is transmitted at ten and some Mbs to twenty and some Mbs. A storage device, such as an HDD recorder, stores the digital data of the digital broadcast signal as it is or stores it by re-encoding (transcoding) the decoded picture so that the compression rate is increased after decoding the digital data of the digital broadcast signal, i.e., it stores it after reducing the amount of data by encoding again with a lower bit rate than the bit rate of the original picture. Reduction in the amount of data leads to an increase in the length of recording time. A device used for re-encoding is referred to as a transcoder.

Recently, various motion picture encoding standards have been proposed for specific fields, which are selected according to characteristics of the standards for markets and purposes of users, etc. By using a transcoder, it is possible to convert standard image data into image data of another standard in accordance with the purpose of use.

Currently, new encoding formats having a higher compression rate than MPEG2 and capable of playing back a picture of higher quality are now being discussed, for example, the H.264 system and VC-1 system are existing formats. By using these systems for encoding, it is possible to encode the same image with a less amount of data, and therefore, an image can be stored for a longer period of time if the storage device has adequate storage capacity. An example is explained below, in which MPEG2 image data is re-encoded (transcoded) into H.264 image data; however, the present application is not limited to this.

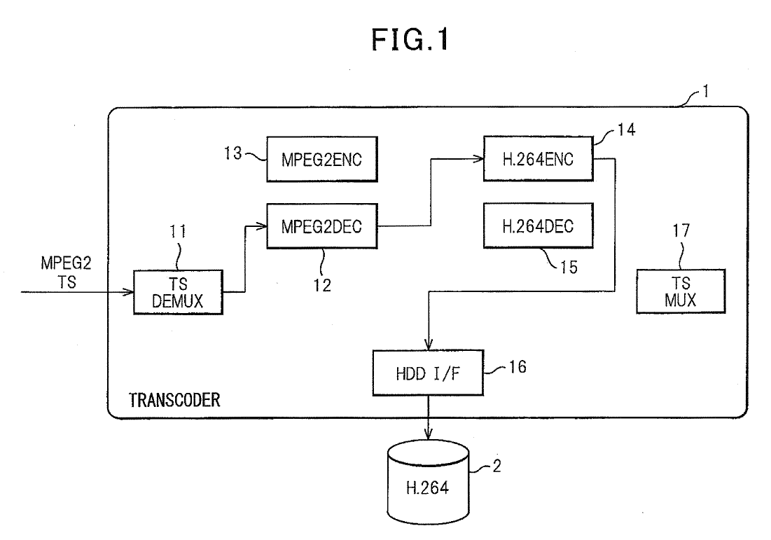

FIG. 1 shows a configuration of a transcoder and a flow of data when converting an MPEG2 transport stream (MPEG2TS) into an H.264 elementary stream (H.264ES) using the transcoder and recording (storing) it in a hard disc drive (HDD) 2, which is a storage device.

As shown in FIG. 1, a transcoder 1 has a transport stream demultiplexer (TSDEMUX) 11 that selects a stream to be input, such as MPEG2TS, and sends an extracted MPEG2 elementary stream (MPEG2ES) to a processing part, an MPEG2 (MPEG2DEC) 12 that decodes MPEG2ES sent from TSDEMUX 11 to generate a decoded picture, an MPEG2 encoder (MPEG2ENC) 13 that encodes the decoded picture to generate MPEG2ES, an H.264 encoder (H.264ENC) 14 that encodes the decoded picture to generate H.264ES, an H.264 decoder (H.264DEC) 15 that decodes H.264ES to generate a decoded picture, a hard disc interface (HDDI/F) 16 that inputs/outputs image data with HDD 2 that stores image data, and a transport stream multiplexer (TSMUX) 17 that selects or combines streams to output. Transcoder 1 is composed of an LSI of one or more chips and each element described above is realized by hardware or software.

When storing MPEG2TS to be input, MPEG2ES is sent from TSDEMUX 11 to MPEG2DEC 12 and MPEG2DEC 12 decodes MPEG2ES to generate a decoded picture and sends it to H.264ENC 14. H.264ENC 14 re-encodes the decoded picture to generate H.264ES and sends it to HDDIF 16. HDDIF 16 writes and stores H.264ES in HDD 2.

In order to efficiently use the storage capacity of a storage device, various methods have been proposed.

JP 2000-341627A describes a recording device that generates free capacity for storing images and audio signals in a storage means by activating a transcoder at a point of time when it is predicted that the free capacity is exhausted in the storage means on the basis of predetermined fixed time intervals or based on information on a program recording, etc.

JP-H09-9193A describes a recording/playback device that receives two or more TV broadcasts by two or more tuners, records them on a HDD of large capacity in an endless manner, and makes it possible to play back data within a predetermined period of time in the past.

JP-2005-348356A describes information processing device that records backup information in order to preserve information even if a shortage of memory capacity should occur without the need of a user's awareness in particular, and which overwrites old data when the capacity for backup runs short.

Recently, the standards for digitalization of an image have become more diverse and more complex and an efficient system capable of coping with them has been demanded.

For example, in the example shown in FIG. 1, when a user requests that the picture data stored in HDD 2 be output as H.264TS, it is only required to read H.264ES stored in HDD 2 through HDDIF 16 and output it from TSMUX 17, and conversion processing is not necessary.

However, when a user requests that the picture data stored in HDD 2 be output as MPEG2TS, conversion is necessary.

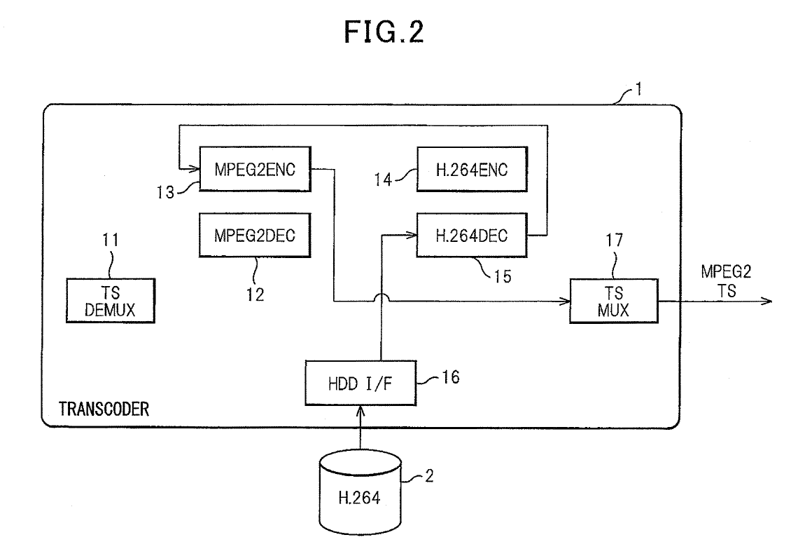

FIG. 2 shows the flow of data when the transcoder reads an H.264 elementary stream (H.264ES) from HDD 2 and converts it into and outputs an MPEG2 transport stream (MPEG2TS).

As shown in FIG. 2, H.264ES stored in HDD 2 is read through HDDIF 16 and sent to H.264DEC 15. H.264DEC 15 decodes H.264ES to generate a decoded picture and sends it to MPEG2ENC 13. MPEG2ENC 13 converts the decoded picture into an MPEG2 elementary stream (MPEG2ES) and then outputs it from TSMUX 17 to MPEG2TS.

As described above, when picture data the standard of which is different from the standard of the picture data stored in HDD 2 is output, conversion processing is necessary. If conversion processing is carried out, a delay occurs according to the period of time required for the conversion processing, and power consumption also increases.

In addition, when picture data mixed with mixed noise is decoded, degradation in picture quality occurs, which would not occur in a picture without noise, and there arises a problem in that the amount of data cannot be compressed sufficiently when the picture data is encoded. As shown in FIG. 1 and FIG. 2, when MPEG2ES is decoded and the decoded picture is encoded to generate H.264ES, and then H.264ES is decoded and the decoded picture is encoded to generate MPEG2ES, decoding and encoding are performed two or more times and therefore it becomes more likely to be affected by noise, and accordingly the above problem in that compression cannot be sufficient becomes more likely to arise.

Further, a storage medium of large capacity, such as HDD and DVD, is now available at a relatively inexpensive cost and a large amount of picture data can be recorded (stored); however, only recording transcoded data will bring about a problem in that such a storage medium of large capacity cannot be effectively made use of. In the above patent documents, the configurations that effectively make use of large capacity have been proposed; however, none of them gives a description of a case where data of different standards is stored.

### SUMMARY

It is an aspect of the embodiments discussed herein to provide in a transcoder, an image storing device, and a method of storing/reading image data, the data of first and second formats of the same image is stored simultaneously in a storage device.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE INVENTION

The features and advantages of the application will be more clearly understood from the following description taken in conjunction with the accompanying drawings, in which:

FIG. 1 is a diagram showing a case where an MPEG2 stream is converted into an H.264 stream using a transcoder and stored in a conventional example;

FIG. 2 is a diagram showing a case where an H.264 stream is converted into an MPEG2 stream using a transcoder and output in a conventional example;

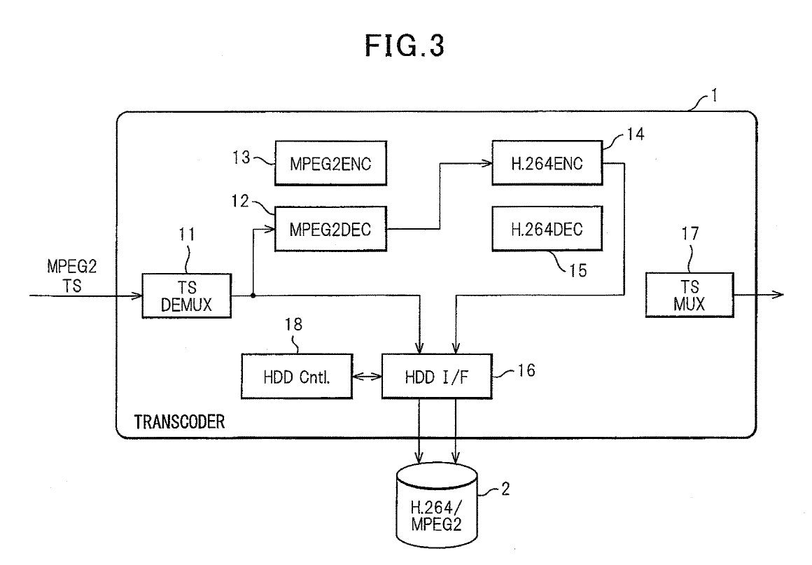

FIG. 3 is a diagram showing the configuration of a transcoder and the flow of data when stored in an embodiment;

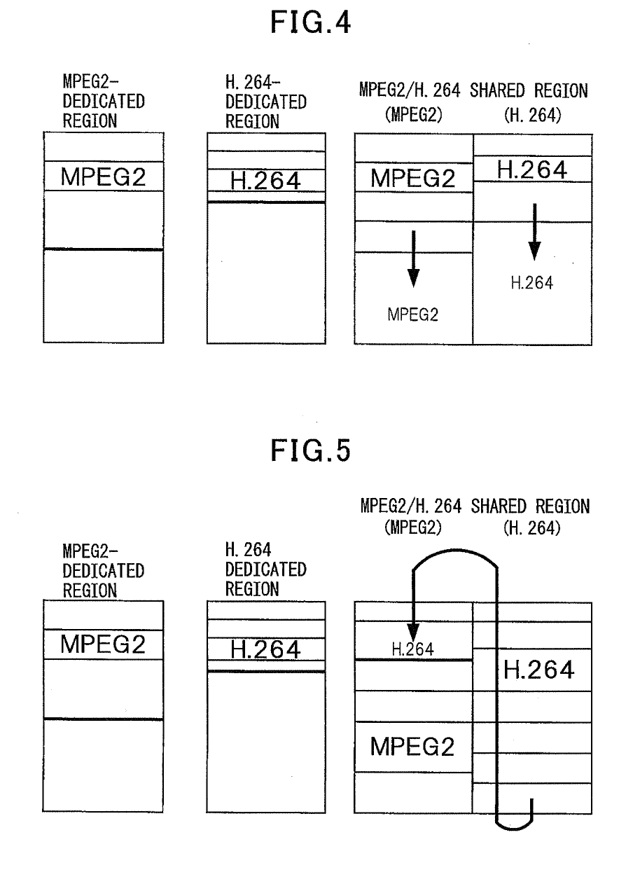

FIG. 4 is a diagram explaining writing in the shared region of the MPEG2/H.264 data streams in an embodiment;

FIG. 5 is a diagram explaining writing in the shared region of the MPEG2/H.264 data streams in an embodiment;

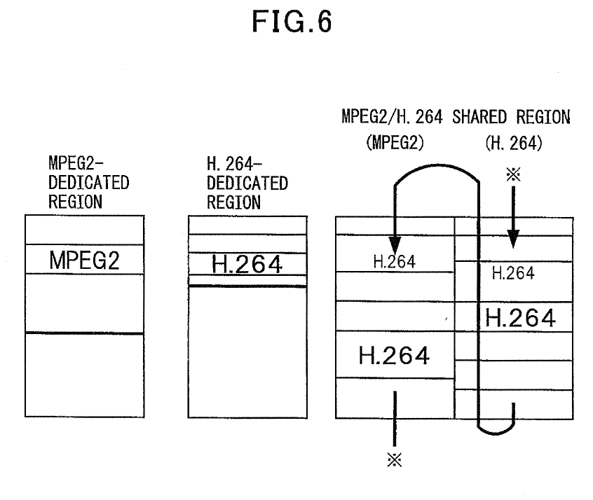

FIG. 6 is a diagram explaining writing in the shared region of the MPEG2/H.264 data streams in an embodiment;

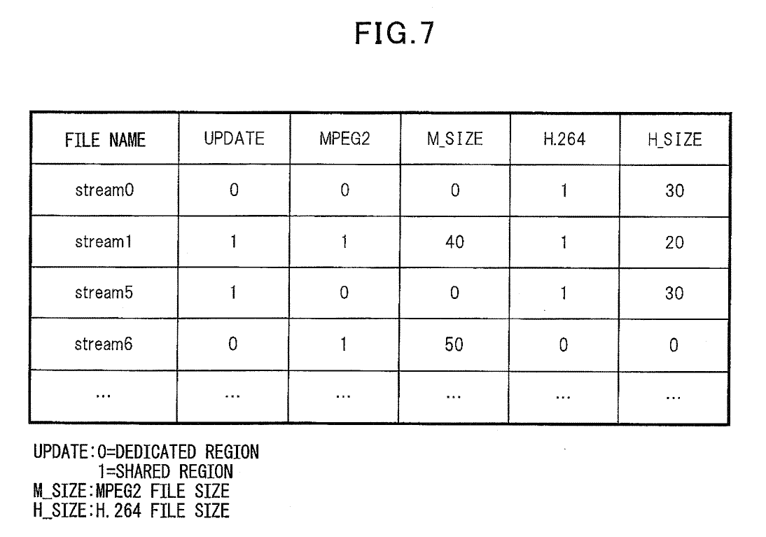

FIG. 7 is a diagram showing an example of a data management table in an HDD control part (HDDCntl.) in an embodiment.

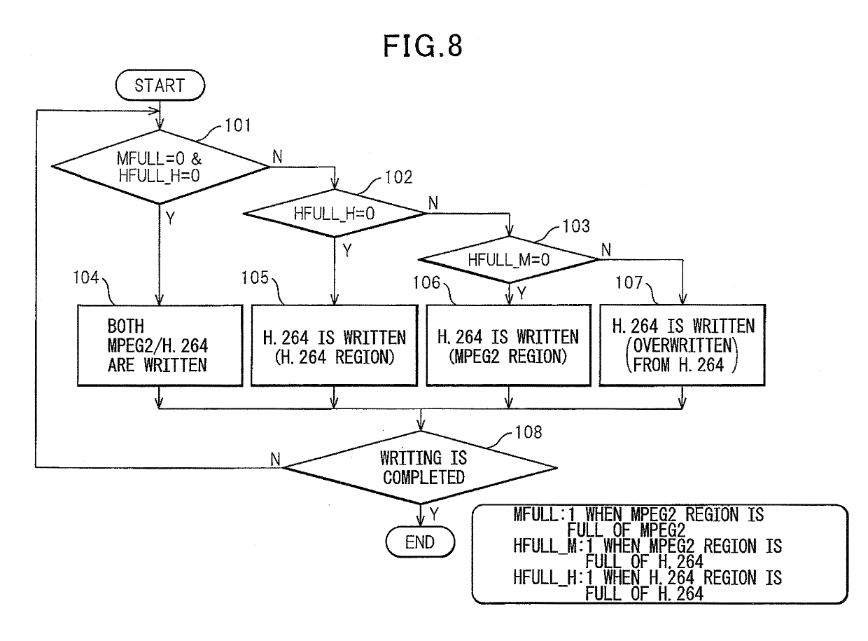

FIG. 8 is a flowchart showing the writing processing control in the shared region of the MPEG2/H.264 data streams in an embodiment;

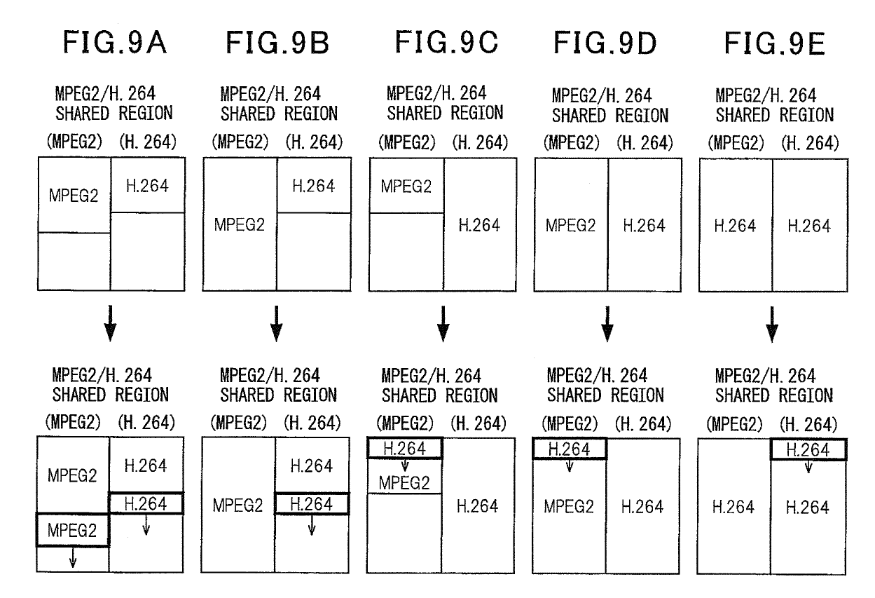

FIGS. 9A to 9E are diagrams explaining writing processing for each case;

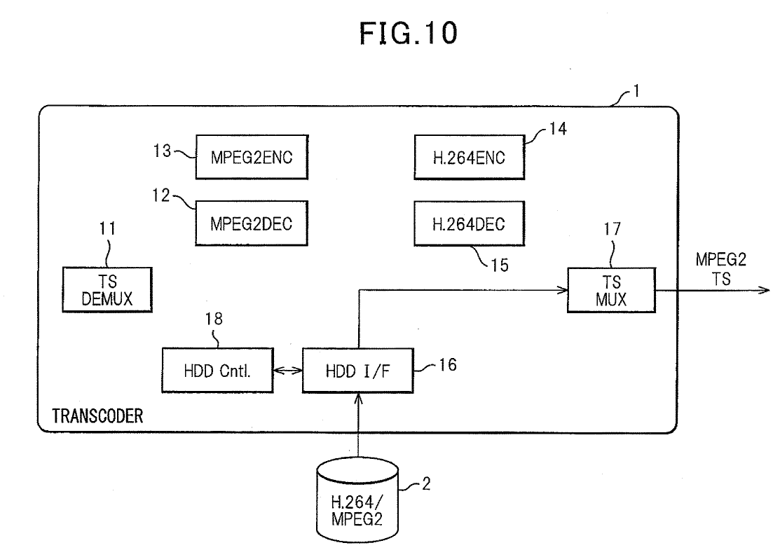

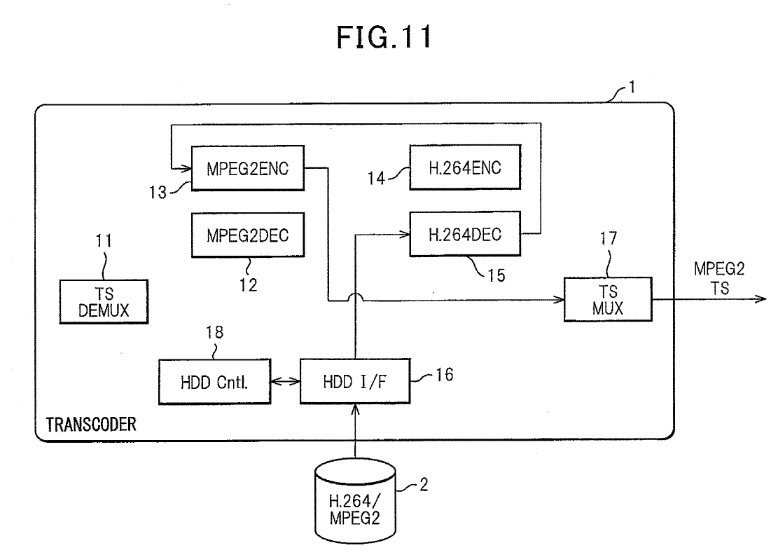

FIG. 10 is a diagram showing the flow of data when read in a transcoder in an embodiment;

FIG. 11 is a diagram showing the flow of data when read in a transcoder in an embodiment; and

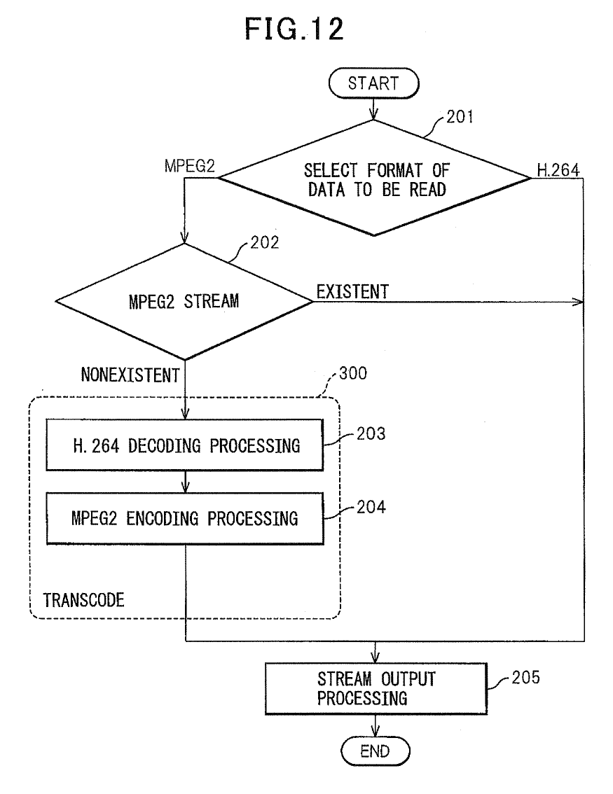

FIG. 12 is a flowchart of reading processing in an embodiment.

### DESCRIPTION OF THE PREFERRED EMBODIMENTS

FIG. 3 shows the configuration of transcoder 1 in an embodiment and the flow of data when converting an MPEG2 transport stream (MPEG2TS) into an H.264 elementary stream (H.264ES) using the transcoder and simultaneously recording (storing) the MPEG2ES and H.264ES of the same picture in hard disc drive (HDD) 2, which is a storage device.

Storing in HDD 2 by transcoder 1 in the embodiment is carried out with the following policy in accordance with the remaining amount of the storage capacity of HDD 2.

(1) When the remaining amount is equal to or more than a predetermined amount, the same image is stored as the image data of both first and second formats.

(2) When the remaining amount is less than the predetermined amount, the second format image data is overwritten and stored in a region in which the first format image data has already been stored.

(3) After all of the first format image data has been rewritten into the second format image data, the already stored second format image data is overwritten by new second format image data in order from data the elapsed time of which after stored is longer.

As obvious from comparison between FIG. 3 and FIG. 1, transcoder 1 in the embodiment differs from the conventional transcoder in FIG. 1 in the provision of an HDD control part (HDDCntl.) 18 and the flow of image data to be stored in HDD 2, and others are the same.

In the conventional transcoder, data is only input/output to/from HDD 2 via HDDIF 16; however, in the present embodiment, the storage region of data output from HDDCntl. 18 is specified in HDD 2. As shown in FIG. 4, the storage region in HDD 2 is divided into an MPEG2-dedicated region, an H.264-dedicated region, and an MPEG2/H.264 shared region.

It is possible for transcoder 1 in the present embodiment to specify the format (standard) of data that a user stores at the time of recording (storing). Here, the picture data to be input is MPEG2TS in conformity with the MPEG2 standard and it is possible for the user to specify the format of data to be stored in HDD 2 as the format of data in conformity with either the MPEG2 standard or the H.264 standard via a terminal, not shown. Instead of the H.264 standard, it is possible to specify to store data in the format in conformity with the VC-1 standard. In either case, it is possible to freely determine which standard the format of picture data to be input and picture data to be stored should be in conformity with.

When the user specifies to store the data MPEG2TS in the format in conformity with the MPEG2 standard in HDD 2, the MPEG2ES extracted from the input MPEG2TS in TSDEMUX 11 is stored as is in the MPEG2-dedicated region in HDD 2 via HDDIF 16 in FIG. 3.

When the user specifies to store the data H.264ES in the format in conformity with the H.264 standard in HDD 2, the input MPEG2TS is sent from TSDEMUX 11 to MPEG2DEC 12 in FIG. 3. MPEG2DEC 12 decodes MPEG2ES to generate a decoded picture and sends it to H.264ENC 14. H.264ENC 14 encodes the decoded picture to generate H.264ES and sends it to HDDIF 16. H.264ES is stored in the H.264-dedicated region in HDD 2 via HDDIF 16 under the control of HDDCntl 18.

When the user does not specify the format of picture data to be stored, for example, when the user records and saves up picture data by automatic programmed recording etc., if there is a sufficient remaining amount of capacity in the MPEG2/H.264 shared region in HDD 2, both MPEG2ES and H.264ES are stored in the MPEG2/H.264 shared region as shown in FIG. 4.

If the remaining amount of capacity is exhausted in the MPEG2/H.264 shared region in HDD 2, new H.264ES is overwritten in the part in which MPEG2ES has already been stored in the MPEG2/H.264 shared region as shown in FIG. 5.

Further, if all the parts in which MPEG2ES has already been stored in the MPEG2/H.264 shared region in HDD 2 are overwritten by H.264ES, new H.264ES is overwritten in the parts in which H.264 has already been stored in the MPEG2/H.264 shared region in order from older part, that is, in order from part where the elapsed time after H.264 is stored is longer as shown in FIG. 6. However, this operation is made optional that a user can select, and carried out only when the user selects and when not selected, this operation is not carried out. Due to this, without selection, when H.264ES has been stored in all of the MPEG2/H.264 shared region, recording (storing) is terminated and all of the picture data recorded so far is saved as H.264ES.

If the user selects the option to overwrite new MPEG2TS in order from older part in the parts in which H.264 has already been stored in the MPEG2/H.264 shared region, it is possible to continue recording endlessly by repeating this operation.

In either way, in the cases in FIG. 5 and FIG. 6, H.264ES the compression rate of which is generally higher is stored in all of the MPEG2/H.264 shared region.

FIG. 7 shows a management table for controlling HDD 2 provided in HDDCntl 18, FIG. 8 shows a flowchart of recording operation processing, and FIG. 9A to FIG. 9E are diagrams for explaining writing processing for each case. With reference to these figures, the writing operation in the embodiment is explained.

As shown in FIG. 7, the data management table has boxes of “File name”, “UPDATE”, “MPEG2”, “H.264”, and “H-SIZE”. In “File name”, the name of an elementary stream ES to be stored is written and each of other boxes represents the attribute of ES to be stored. In “UPDATE”, “0” is set when the region of HDD 2 in which ES is written is the dedicated region, and “1” is set when it is the shared region. “MPEG2” indicates that ES to be written (stored) is MPEG2ES, “M-SIZE” indicates the size of MPEG2ES to be written, “H.264” indicates that ES to be written (stored) is H.264ES, and “H-SIZE” indicates the size of H.264ES to be written.

As a result, in the case where “UPDATE”=0 and “MPEG2”=1, when the remaining capacity of the MPEG2-dedicated region is larger than the size of MPEG2ES desired to be recorded, MPEG2ES is written in the MPEG2-dedicated region. If the remaining capacity of the MPEG2-dedicated region is smaller than the size of MPEG2ES desired to be recorded, a warning message is issued to the user and a standby state continues until the instruction of the user is received.

In the case where “UPDATE”=0 and “H.264”=1, when the remaining capacity of the H.264-dedicated region is larger than the size of H.2642ES desired to be recorded, H.264ES is written in the H.264-dedicated region as a result. If the remaining capacity of the H.264-dedicated region is smaller than the size of H.264ES desired to be recorded, a warning message is issued to the user and a standby state continues until the instruction of the user is received.

In the case where “UPDATE”=1, writing in the shared region is carried out. This is explained below with reference to FIG. 8 and FIG. 9A to FIG. 9E.

In FIG. 8, MFULL is 1 when the MPEG2 region of the shared region is full of MPEG2ES, and 0 in other cases. HFULL_M is 1 when the MPEG2 region of the shared region is full of H.264, and 0 in other cases. HFULL_H is 1 when the H.264 region of the shared region is full of H.264, and 0 in other cases. Here, it is assumed that the case where the remaining capacity is smaller than the size of ES to be written newly is included in the case where the region is full.

In step 101 in FIG. 8, whether MFULL=0 and HFULL_H=0 is determined, that is, whether the MPEG2 region of the shared region is not full of MPEG2ES and the H.264 region of the shared region is not also full of H.264ES is determined. When both are zero, the remaining capacity is enough both in the MPEG2 region and in the H.264 region of the shared region, as shown in FIG. 9A, and therefore, the procedure proceeds to step 104 and when one of them is not zero, the procedure proceeds to step 102.

In step 102, whether HFULL_H=0 is determined, that is, whether the H.264 region of the shared region is not full of H.264TS is determined. When it is not full (HFULL_H=0), the MPEG2 region of the shared region is full of MPEG2ES according to the determination result in step 101 but the remaining capacity in the H.264 region of the shared region is enough as shown in FIG. 9B. When it is not full, the procedure proceeds to step 105 and if it is full, the procedure proceeds to step 103.

In step 103, whether HFULL_M=0 is determined, that is, whether the MPEG2 region of the shared region is not full of H.264ES is determined. When it is not full (HFULL_M=0), the H.264 region of the shared region is full of H.264ES according to the determination result in step 102 but the MPEG2 region of the shared region is not full of H.264ES as shown in FIG. 9C or FIG. 9D. FIG. 9C shows a state where MPEG2ES is written in part of the MPEG2 region of the shared region and FIG. 9D shows a state where the MPEG2 region of the shared region is full of MPEG2ES. In general, for the same picture, the amount of data of MPEG2ES is larger than that of H.264ES, and therefore, the state shown in FIG. 9C does not occur usually; however, for example, when only MPEG2ES in the MPEG2 region is deleted, the state in FIG. 9C will be brought about. Further, in this state, H.264ES is overwritten in the MPEG2 region of the share region after MPEG2ES has been written therein, and therefore, a state where MPEG2ES remains in the MPEG2 region of the shared region is also included in the above state. In addition, a state where H.264ES is written in part of the MPEG2 region of the shared region is also included in the above state. The state where the determination result is not true is a state where the MPEG2 region and the H.264 region of the shared region are full of H.264ES. When the determination result is true, the procedure proceeds to step 103 and when not, the procedure proceeds to step 107.

In step 104, as shown on the lower side in FIG. 4 and FIG. 9A, because the remaining capacity in the MPEG2 region and the H.264 region of the shared region is enough to newly store MPEG2ES and H.264ES, MPEG2ES is written in the MPEG2 region of the shared region and H.264ES is written in the H.264 region of the shared region.

In step 105, as shown on the lower side in FIG. 9B, MPEG2ES is written in the MPEG2 region of the shared region and no more MPEG2ES cannot be written therein. However, the remaining capacity in the H.264 region of the shared region is enough to newly write H.264ES, and therefore, only H.264ES is written in the H.264ES region of the shared region.

In step 106, as shown on the lower side in FIG. 5, FIG. 9C, and FIG. 9D, MPEG2ES is written in the MPEG2 region of the shared region and no more MPEG2ES cannot be written therein. Further, the remaining capacity in the H.264 region of the shared region is not enough to newly write H.264ES, and therefore, only H.264ES is written in the MPEG2 region of the shared region. Due to this, in the MPEG2 region of the shared region, MPEG2ES is overwritten by new H.264ES in order from older one, i.e., in order from one the elapsed time of which after it is written is longer.

In step 107, as shown on the lower side in FIG. 6 and FIG. 9E, the MPEG2 region and the H.264 region in the shared region are already full of H.264ES. In this state, only H.264ES is overwritten by new H.264ES in the MPEG2 region and the H.264 region of the shared region in order from older one, i.e., in order from one the elapsed time of which after it is written is longer. Writing is thus carried out endlessly by overwriting, when the H.264 region of the shared region becomes full again, new H.264ES in the MPEG2 region of the shared region and by overwriting again, when the MPEG2 region of the shared region becomes full, new H.264ES in the H.264 region of the shared region.

In step 108, whether writing is completed is determined, and when not completed, the procedure returns to step 101.

The writing operation in the transcoder in the embodiment has been explained as above and now the reading operation is explained below.

FIG. 10 and FIG. 11 show the flow of data when transcoder 1 in the embodiment reads and outputs picture data stored in HDD 2, where FIG. 10 shows a case where a stream (ES) in a desired format with the file name specified by a user is stored in HDD 2 and FIG. 11 shows a case where a stream (ES) in a desired format with the file name specified by a user is not stored in HDD 2 but ES in another format of the same picture data is stored in HDD 2. Specifically, H.264ES with the file name specified by the user is stored in HDD 2 but MPEG2ES is not stored, as shown in FIG. 9E.

As shown in FIG. 10, when the stream (ES) in the desired format with the name specified by the user is stored in HDD 2, the ES is read from HDD 2 via HDDI/F 16 and output from TSMUX 17.

As shown in FIG. 11, when MPEG2ES with the file name specified by the user is not present in HDD 2 but H.264ES with the file name is stored, the H.264ES is read from HDD 2 via HDDI/F 16 and sent to H.264DEC 15. H.264DEC 15 decodes H.264ES to generate a decoded picture and sends it to MPEG2ENC 13. MPEG2ENC 13 encodes the decoded picture to generate MPEG2ES and outputs MPEG2TS from TSMUX 17.

As described above, when the picture data in the format specified by the user is present in HDD 2, the transcoder in the embodiment reads and outputs it as is. Due to this, the conversion processing is not necessary.

FIG. 12 is a flowchart of reading processing in the transcoder in the embodiment.

In step 201, a format of picture data to be read is selected. When it is H.264ES, the procedure proceeds to step 205 and when MPEG2ES, the procedure proceeds to step 202.

In step 202, whether MPEG2ES is stored in HDD 2 is determined and when stored, the procedure proceeds to step 205 and when not stored, the procedure proceeds to step 203.

In step 203, H.264DEC 15 decodes H.264ES.

In step 204, MPEG2ENC 13 carries out processing of encoding the decoded picture to generate MPEG2ES and then the procedure proceeds to step 205.

The combination of the processing in step 203 and that in step 204 is so-called transcoding processing and is shown generally in step 300.

In step 205, stream processing of outputting TS in the specified format is carried out.

As described above, by storing the same picture data both as MPEG2ES and H.264ES when the remaining storage capacity of the storage device (HDD) is enough, it is possible to output data without extra transcoding processing when outputting MPEG2ES and therefore efficiency and reduction in power consumption can be obtained.

The embodiment of the present application has been explained as above; however, the present application is not limited to this and it is obvious to the person skilled in the art that there can be various modification examples.

For example, the transcoder in the embodiment has a configuration in which MPEG2TS is input and MPEG2TS or H.264TS is output; however, with this configuration of the transcoder in the embodiment, it is possible to input MPEG2TS, H.264TS, and a picture not encoded yet and output MPEG2TS, H.264TS, and a decoded picture.

Further, it is also possible to use a system in conformity with not only H.264 but also VC-1 or other systems in conformity with picture encoding standards with a high compression rate as a system for storing together with MPEG2ES.

An example has been explained, in which an HDD is used as a storage device; however, it is also possible to use another large-capacity storage medium, such as a DVD drive device.

In the embodiment, an example is shown, in which the storage region is divided into the MPEG2-dedicated region, the H.264-dedicated region, and the shared region and the shared region is further divided into the MPEG2 region and the H.264 region; however, it is also possible to dynamically manage all of the regions based on the above-mentioned basic policy without such a division of the region.

The configuration in the embodiment can be applied to a transcoder that stores picture data in a storage device and outputs stored picture data as picture data in two or more formats, and to an image storage device and a method of storing/reading image data having such a transcoder.

According to the present embodiment, it is possible to easily output the picture data in a format that a user requests without conversion processing, and further, power consumption can be reduced and the influence of noise can also be reduced because conversion processing is not carried out.

By storing data in two or more formats, it is possible to provide data in the format that the user requests by transcoding data of another format even if data in the desired format is lost in an incident event, i.e. the backup capability of data is realized.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

We claim:

1. A transcoder to which first format image data encoded in a first format is input and which outputs the first format image data and second format image data encoded in a second format different from the first format, comprising:
an interface with a storage device; and
a storage device control part that controls storing and reading in the storage device via the interface, wherein
the image data of the first and second formats of the same image is stored simultaneously in the storage device via the interface.

2. The transcoder according to claim 1, comprising:
a first decoder that decodes first format image data; and
a first encoder that encodes a decoded picture by a second format different from the first format, wherein
input first format image data and second format image data, which is a decoded picture decoded from the input first format image data by the first decoder, encoded by the first encoder is stored simultaneously in the storage device via the interface.

3. The transcoder according to claim 1, wherein in accordance with the remaining capacity of storage capacity of the storage device, the storage device control part controls to:
(1) store the same image as first and second format image data when the remaining capacity is equal to or more than a predetermined amount of capacity; and
(2) overwrite and store second format image data in a region where first format image data has already been stored when the remaining capacity is less than the predetermined amount of capacity.

4. The transcoder according to claim 3, wherein the storage device control part:
sets a first dedicated region for storing only first format image data, a second dedicated region for storing only second format image data, and a shared region for storing image data of first and second formats in the storage capacity of the storage device; and
controls to overwrite and store second format image data in a region where first format image data has already been stored when the remaining capacity in the shared region is less than the predetermined amount of capacity.

5. The transcoder according to claim 3, wherein the storage device control part controls so that (3) the second format image data already stored is overwritten by new second format image data to be stored in order from data the elapsed time of which after it is stored is longer when all of the first format image data has been rewritten into the second format image data.

6. The transcoder according to claim 5, wherein the storage device control part:
sets a first dedicated region for storing only first format image data, a second dedicated region for storing only second format image data, and a shared region for storing image data of first and second formats in the storage capacity of the storage device; and
controls so that the second format image data already stored in the shared region is overwritten by new second format image data to be stored in an order based on the elapsed time of which after it is stored is longer when the shared region is full of the stored second format image data.

7. The transcoder according to claim 1, wherein when the picture data specified by a user is stored as both the first image data and the second image data in the storage device, the image data of the format desired by the user is read and output.

8. The transcoder according to claim 1, comprising:
a second decoder that decodes second format image data; and
a second encoder that encodes a decoded picture by the first format, wherein
the transcoder decodes the second format image data read from the storage device using the second decoder to generate a decoded picture and encodes the decoded picture using the second encoder to generate and output first format image data when the first format image data requested by a user is not present in the picture data stored in the storage device; however, corresponding second format image data is present.

9. The transcoder according to claim 1, wherein the first format is a format in conformity with the MPEG2 standard and the second format is a format in conformity with the H.264 standard.

10. The transcoder according to claim 1, wherein the first format is a format in conformity with the MPEG2 standard and the second format is a format in conformity with the VC-1 standard.

11. An image storage device comprising:
a transcoder according to claim 1; and
a storage device that stores and reads image data via the interface and the storing and reading of which are controlled by the storage device control part.

12. A method of storing/reading image data for storing image data to be input and outputting stored image data at the request of a user, wherein:
image data to be input is first format image data encoded in a first format and image data to be output is the first format image data and second format image data encoded in a second format different from the first format; and
the image data of the first and second formats of the same image is stored simultaneously in a storage device.

13. The method of storing/reading image data according to claim 12, wherein the input first format image data and the second format image data, which is the encoded data of decoded picture decoded from the input first format image data, is stored simultaneously in the storage device.

14. The method of storing/reading image data according to claim 12, wherein in accordance with the remaining capacity of storage capacity of the storage device:
(1) the same image is stored as first and second format image data when the remaining capacity is equal to or more than a predetermined amount of capacity; and
(2) second format image data is overwritten and stored in a region where first format image data has already been stored when the remaining capacity is less than the predetermined amount of capacity.

15. The method of storing/reading image data according to claim 14, wherein:
a first dedicated region for storing only first format image data, a second dedicated region for storing only second format image data, and a shared region for storing image data of first and second formats are set in the storage capacity of the storage device; and
second format image data is overwritten and stored in a region where first format image data has already been stored when the remaining capacity in the shared region is less than the predetermined amount of capacity.

16. The method of storing/reading image data according to claim 14, wherein (3) the second format image data already stored is overwritten by new second format image data to be stored in an order based on the elapsed time of which after it is stored is longer when all of the first format image data has been rewritten into the second format image data.

17. The method of storing/reading image data according to claim 16, wherein:
a first dedicated region for storing only first format image data, a second dedicated region for storing only second format image data, and a shared region for storing image data of first and second formats are set in the storage capacity of the storage device; and
the second format image data already stored in the shared region is overwritten by new second format image data to be stored in an order based on the elapsed time of which after it is stored is longer when the shared region is full of the second format image data.

18. The method of storing/reading image data according to claim 12, wherein when the picture data specified by a user is stored as both the first image data and the second image data in the storage device, the image data of the format desired by the user is read and output.

19. The method of storing/reading image data according to claim 12, comprising:
a second decoder that decodes second format image data; and
a second encoder that encodes a decoded picture by the first format, wherein
the second format image data read from the storage device is decoded using the second decoder to generate a decoded picture and the decoded picture is encoded using the second encoder to generate and output first format image data when the first format image data requested by a user is not present in the picture data stored in the storage device; however, corresponding second format image data is present.

20. The method of storing/reading image data according to claim 12, wherein the first format is a format in conformity with the MPEG2 standard and the second format is a format in conformity with the H.264 standard.

21. The method of storing/reading image data according to claim 12, wherein the first format is a format in conformity with the MPEG2 standard and the second format is a format in conformity with the VC-1 standard.
